(19) United States
(12) Patent Application Publication
(10) Pub. No.: US 2013/0266481 A1
(43) Pub. Date: Oct. 10, 2013

(54) BLOOD GLUCOSE TEST STRIP

(71) Applicants: RAMZI ABULHAJ, Charlotte, NC (US); RICK ADMANI, Charlotte, NC (US)

(72) Inventors: RAMZI ABULHAJ, Charlotte, NC (US); RICK ADMANI, Charlotte, NC (US)

(73) Assignee: PRODIGY DIABETES CARE, LLC, CHARLOTTE, NC (US)

(21) Appl. No.: 13/440,041

(22) Filed: Apr. 5, 2012

(51) Int. Cl. G01N 27/00

(52) U.S. Cl. 422/82.01

(57) ABSTRACT

The present invention provides a blood glucose test strip for use in a six-pin blood glucose meter, including: a substrate; a first conductive lead disposed on a surface of the substrate; a second conductive lead disposed on the surface of the substrate; and a third conductive lead disposed on the surface of the substrate; wherein a portion of each of the first conductive lead, the second conductive lead, and the third conductive lead resides within a blood sample chamber disposed on the surface of the substrate; and wherein blood glucose testing is initiated by the blood glucose meter only when blood in the blood sample chamber electrically couples the first conductive lead and the third conductive lead.

### FIELD OF THE INVENTION

The present invention relates generally to blood glucose test strips for use in blood glucose meters. More specifically, the present invention relates to a six-pin, three-lead blood glucose test strip for use in a six-pin blood glucose meter. Advantageously, the third lead is used to assure an adequate blood sample prior to testing being enabled/initiated.

### BACKGROUND OF THE INVENTION

Persons with Type I and Type II diabetes have blood glucose levels that are not properly regulated by their bodies. As a result, these persons often carry blood glucose meters to periodically check their blood glucose levels. If their blood glucose levels are of concern, appropriate action may be taken. For example, insulin may be administered.

Blood glucose meters typically include a base unit that houses control and test electronics required to test the blood glucose levels in a blood sample. They also typically include a blood glucose test strip receptacle that accepts a disposable blood glucose test strip. One end of the blood glucose test strip is inserted into the blood glucose test strip receptacle, while an exposed area contains a sample chamber and a reaction site in/on which a user deposits a drop of blood, which is often obtained by pricking the skin with a lancet. Paths or traces of conductive material, or leads, run from the reaction site, which includes various reagent chemicals, to the end inserted into the base unit, thereby electrically coupling the reaction site to the control and test electronics. The leads of the blood glucose test strip make contact with points of contact, or pins, disposed within the blood glucose test strip receptacle. In effect, the blood completes a circuit so that testing may be done over a relatively short period of time.

Most conventional blood glucose meters utilize four pins and two leads. Three lead versions have been developed, however, with the first two leads designed to enable/initiate testing and the third lead designed to ensure that an adequate blood sample is present—issuing an appropriate “low blood” warning or discarding a testing result if blood is not detected by the third lead within a predetermined period of time, for example. An inadequate blood sample is significant as blood glucose levels are determined using a formula that takes into account reagent chemical amount and presumed blood sample amount. Too low a blood sample amount skews the calculation. Six pin versions of blood glucose meters are preferable, but none have been developed that utilize three leads, among other shortcomings. Thus, what is needed in the art is a six-pin, three-lead blood glucose test strip for use in a six-pin blood glucose meter, with the third lead actually enabling/initiating testing only when an adequate blood sample is present, thereby ensuring accurate testing results.

### BRIEF SUMMARY OF THE INVENTION

In one exemplary embodiment, the present invention provides a blood glucose test strip for use in a six-pin blood glucose meter, including: a substrate; a first conductive lead disposed on a surface of the substrate, wherein the first conductive lead is electrically coupled to one or more of a fifth pin and a sixth pin of the blood glucose meter when the blood glucose test strip is inserted into the blood glucose meter; a second conductive lead disposed on the surface of the substrate, wherein the second conductive lead is electrically coupled to one or more of a second pin and a fourth pin of the blood glucose meter when the blood glucose test strip is inserted into the blood glucose meter; and a third conductive lead disposed on the surface of the substrate, wherein the third conductive lead is electrically coupled to a third pin of the blood glucose meter when the blood glucose test strip is inserted into the blood glucose meter. A portion of each of the first conductive lead, the second conductive lead, and the third conductive lead resides within a blood sample chamber disposed on the surface of the substrate. Blood glucose testing is initiated by the blood glucose meter only when blood in the blood sample chamber electrically couples the first conductive lead and the third conductive lead. Optionally, the second conductive lead is electrically coupled to both the second pin and the fourth pin of the blood glucose meter when the blood glucose test strip is inserted into the blood glucose meter. Optionally, the second conductive lead is electrically coupled to both the second pin and the fourth pin of the blood glucose meter when the blood glucose test strip is inserted into the blood glucose meter via a conductive bridge.

In another exemplary embodiment, the present invention provides a blood glucose test strip method for use with a six-pin blood glucose meter, including: providing a substrate; disposing a first conductive lead on a surface of the substrate, wherein the first conductive lead is electrically coupled to one or more of a fifth pin and a sixth pin of the blood glucose meter when the blood glucose test strip is inserted into the blood glucose meter; disposing a second conductive lead on the surface of the substrate, wherein the second conductive lead is electrically coupled to one or more of a second pin and a fourth pin of the blood glucose meter when the blood glucose test strip is inserted into the blood glucose meter; and disposing a third conductive lead on the surface of the substrate, wherein the third conductive lead is electrically coupled to a third pin of the blood glucose meter when the blood glucose test strip is inserted into the blood glucose meter. A portion of each of the first conductive lead, the second conductive lead, and the third conductive lead resides within a blood sample chamber disposed on the surface of the substrate. The method also includes initiating blood glucose testing by the blood glucose meter only when blood in the blood sample chamber electrically couples the first conductive lead and the third conductive lead. Optionally, the second conductive lead is electrically coupled to both the second pin and the fourth pin of the blood glucose meter when the blood glucose test strip is inserted into the blood glucose meter. Optionally, the second conductive lead is electrically coupled to both the second pin and the fourth pin of the blood glucose meter when the blood glucose test strip is inserted into the blood glucose meter via a conductive bridge.

In a further exemplary embodiment, the present invention provides a blood glucose test strip for use in a six-pin blood glucose meter, including: a substrate; a first conductive lead disposed on a surface of the substrate; a second conductive lead disposed on the surface of the substrate; and a third conductive lead disposed on the surface of the substrate; wherein a portion of each of the first conductive lead, the second conductive lead, and the third conductive lead resides within a blood sample chamber disposed on the surface of the substrate; and wherein blood glucose testing is initiated by the blood glucose meter only when blood in the blood sample chamber electrically couples the first conductive lead and the third conductive lead. The first conductive lead is electrically coupled to one or more of a fifth pin and a sixth pin of the blood glucose meter when the blood glucose test strip is inserted into the blood glucose meter. The second conductive lead is electrically coupled to one or more of a second pin and a fourth pin of the blood glucose meter when the blood glucose test strip is inserted into the blood glucose meter. Optionally, the second conductive lead is electrically coupled to both the second pin and the fourth pin of the blood glucose meter when the blood glucose test strip is inserted into the blood glucose meter. Optionally, the second conductive lead is electrically coupled to both the second pin and the fourth pin of the blood glucose meter when the blood glucose test strip is inserted into the blood glucose meter via a conductive bridge. The third conductive lead is electrically coupled to a third pin of the blood glucose meter when the blood glucose test strip is inserted into the blood glucose meter.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 is a schematic diagram illustrating one exemplary embodiment of the six-pin, three-lead blood glucose test strip of the present invention; and

FIG. 2 is a flow chart illustrating one exemplary embodiment of the six-pin, three-lead blood glucose test strip method of the present invention.

### DETAILED DESCRIPTION OF THE INVENTION

Again, most conventional blood glucose meters utilize four pins and two leads. Three lead versions have been developed, however, with the first two leads designed to enable/initiate testing and the third lead designed to ensure that an adequate blood sample is present—issuing an appropriate “low blood” warning or discarding a testing result if blood is not detected by the third lead within a predetermined period of time, for example. An inadequate blood sample is significant as blood glucose levels are determined using a formula that takes into account reagent chemical amount and presumed blood sample amount. Too low a blood sample amount skews the calculation. Six pin versions of blood glucose meters are preferable, but none have been developed that utilize three leads, among other shortcomings. Thus, what is needed in the art is a six-pin, three-lead blood glucose test strip for use in a six-pin blood glucose meter, with the third lead actually enabling/initiating testing only when an adequate blood sample is present, thereby ensuring accurate testing results.

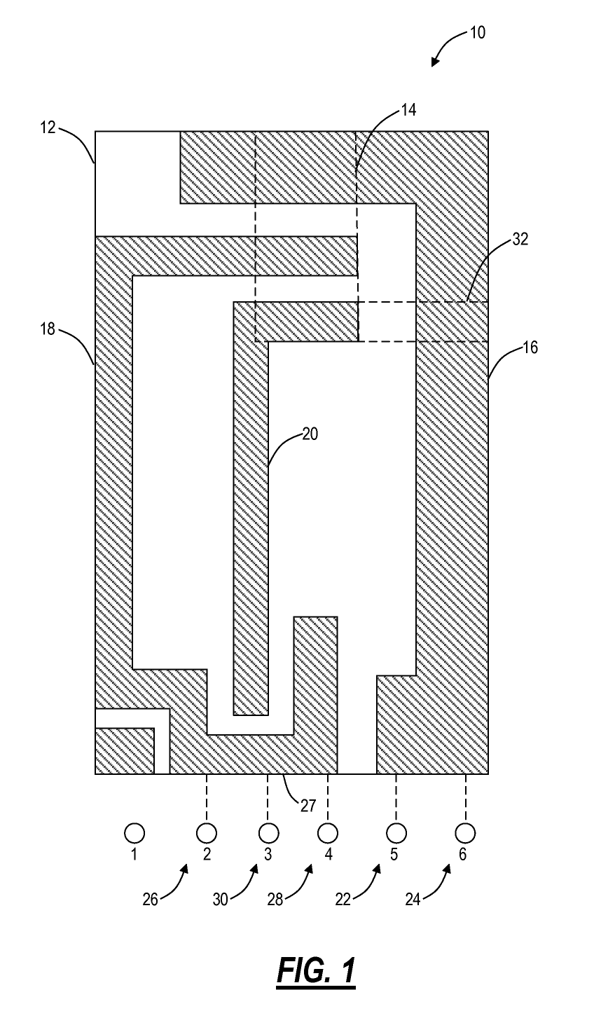

Referring to FIG. 1, in one exemplary embodiment, the blood glucose test strip 10 of the present invention includes a small substrate 12, such as polyethylene terephthalate (PET) or the like, with a sample area on its surface on which one or more reagent chemicals are disposed that selectively react with a blood sample. When subsequent layers are affixed to the substrate 12, this sample area forms a sample chamber 14, in that a void is present in which the blood sample is selectively disposed. In general, the substrate 12 typically has a length on the order of millimeters to tens of millimeters, a width on the order of millimeters to tens of millimeters, and a thickness on the order of millimeters. The sample chamber 14 typically has a length on the order of millimeters, a width on the order of millimeters, and a height on the order of millimeters. A plurality of conductive leads, manufactured from silver ink and carbon or the like, are deposited on the surface of the substrate 12 and run, partially, through the sample chamber 14, such that the blood sample completes a circuit so that testing may be done by the control and test electronics, analyzing the reaction between the blood sample and the one or more reagent chemicals. In general, each of the conductive leads comprises one or more vertical portions that run the length of the blood glucose test strip 10 and one or more horizontal portions that run the width of the blood glucose test strip 10, although it will be readily apparent to those of ordinary skill in the art that each of the conductive leads may assume many suitable shapes. Each of the conductive leads typically has a length on the order of millimeters to tens of millimeters, a width on the order of millimeters to tens of millimeters, and a thickness on the order of millimeters. The conductive leads are deposited on the substrate by printing CVD, or the like, for example.

The plurality of conductive leads includes a first, working lead 16; a second, testing lead 18; and a third, enabling/initiating lead 20. Testing is enabled/initiated only when the blood sample electrically connects the first lead 16, the second lead 18, and the third lead 20, with contact with the third lead 20 being the ultimate trigger for testing. If the third lead 20 is not contacted by the blood sample, the blood glucose meter sits idle and no testing is done. This is a novel functionality for this third lead 20, as all conventional blood glucose testing systems enable/initiate testing when the first and second leads are coupled, with the third lead simply being a “low blood” indicator at most.

Upon insertion of the blood glucose test strip 10 into the blood glucose meter, the first lead 16 is electrically coupled to pins five 22 and/or six 24 of the six-pin arrangement. The second lead 18 is electrically coupled to pins two 26 and/or four 28 of the six-pin arrangement. Preferably, the second lead 18 is electrically coupled to both pins two 26 and four 28 of the six-pin arrangement via a conductive bridge 27. The third lead 20 is electrically coupled to pin three 30 of the six-pin arrangement, optionally crossing the conductive bridge 27. The leads 16, 18, and 20 are coupled to the various pins 22, 24, 26, 28, and 30 via appropriate exposed portions that make direct physical contact with exposed metal associated with the pins 22, 24, 26, 28, and 30, although other suitable methodologies for making secure electrical connections may, of course, be employed.

Again, testing is enabled/initiated only when the blood sample electrically connects the first lead 16, the second lead 18, and the third lead 20, with contact with the third lead 20 being the trigger for testing. If the third lead 20 is not contacted by the blood sample, the blood glucose meter sits idle and no testing is done. This is a novel functionality for this third lead 20, as all conventional blood glucose testing systems enable/initiate testing when the first and second leads are coupled, with the third lead simply being a “low blood” indicator at most. It is advantageous for testing to be triggered only when a full blood sample is present, as described above.

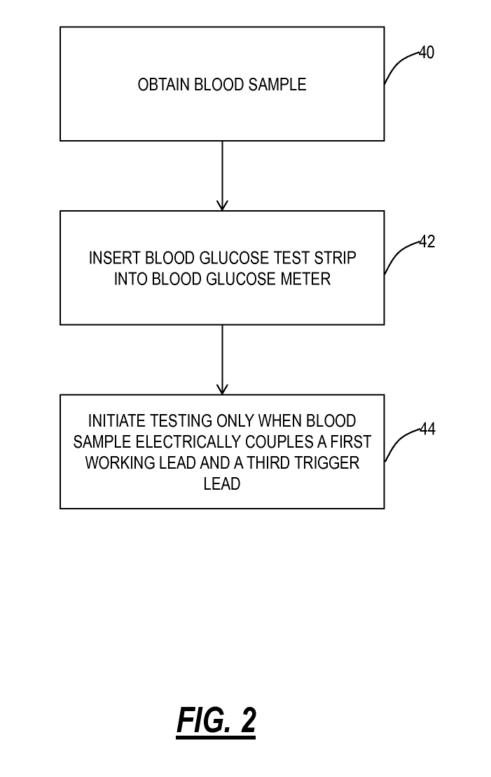

This approach is further illustrated in FIG. 2, which shows the obtaining of a blood sample 40, the insertion of the blood glucose test strip into the blood glucose meter 42, and the enabling/initiating of testing only when the blood sample electrically couples the first, working lead and the third, trigger lead 44.

In addition to the above, the blood glucose test strip 10 may include any number and/or arrangement of additional layers, and may include a sample chamber vent 32 or the like for allowing air to escape from the sample chamber 14 as a blood sample is drawn in. In the exemplary embodiment illustrated, this sample chamber vent 32 runs substantially horizontally across the width of the substrate 12.

Although the present invention has been illustrated and described herein with reference to preferred embodiments and specific examples thereof, it will be readily apparent to those of ordinary skill in the art that other embodiments and examples may achieve like results and/or perform similar functions. All such equivalent embodiments and examples fall within the spirit and scope of the present invention, are contemplated thereby, and are intended to be covered by the following claims.

What is claimed is:

1. A blood glucose test strip for use in a six-pin blood glucose meter, comprising:
a substrate;
a first conductive lead disposed on a surface of the substrate, wherein the first conductive lead is electrically coupled to one or more of a fifth pin and a sixth pin of the blood glucose meter when the blood glucose test strip is inserted into the blood glucose meter;
a second conductive lead disposed on the surface of the substrate, wherein the second conductive lead is electrically coupled to one or more of a second pin and a fourth pin of the blood glucose meter when the blood glucose test strip is inserted into the blood glucose meter; and
a third conductive lead disposed on the surface of the substrate, wherein the third conductive lead is electrically coupled to a third pin of the blood glucose meter when the blood glucose test strip is inserted into the blood glucose meter.

2. The blood glucose test strip of claim 1, wherein a portion of each of the first conductive lead, the second conductive lead, and the third conductive lead resides within a blood sample chamber disposed on the surface of the substrate.

3. The blood glucose test strip of claim 2, wherein blood glucose testing is initiated by the blood glucose meter only when blood in the blood sample chamber electrically couples the first conductive lead and the third conductive lead.

4. The blood glucose test strip of claim 1, wherein the second conductive lead is electrically coupled to both the second pin and the fourth pin of the blood glucose meter when the blood glucose test strip is inserted into the blood glucose meter.

5. The blood glucose test strip of claim 4, wherein the second conductive lead is electrically coupled to both the second pin and the fourth pin of the blood glucose meter when the blood glucose test strip is inserted into the blood glucose meter via a conductive bridge.

6. A blood glucose test strip method for use with a six-pin blood glucose meter, comprising:
providing a substrate;
disposing a first conductive lead on a surface of the substrate, wherein the first conductive lead is electrically coupled to one or more of a fifth pin and a sixth pin of the blood glucose meter when the blood glucose test strip is inserted into the blood glucose meter;
disposing a second conductive lead on the surface of the substrate, wherein the second conductive lead is electrically coupled to one or more of a second pin and a fourth pin of the blood glucose meter when the blood glucose test strip is inserted into the blood glucose meter; and
disposing a third conductive lead on the surface of the substrate, wherein the third conductive lead is electrically coupled to a third pin of the blood glucose meter when the blood glucose test strip is inserted into the blood glucose meter.

7. The blood glucose test strip method of claim 6, wherein a portion of each of the first conductive lead, the second conductive lead, and the third conductive lead resides within a blood sample chamber disposed on the surface of the substrate.

8. The blood glucose test strip method of claim 7, further comprising initiating blood glucose testing by the blood glucose meter only when blood in the blood sample chamber electrically couples the first conductive lead and the third conductive lead.

9. The blood glucose test strip method of claim 6, wherein the second conductive lead is electrically coupled to both the second pin and the fourth pin of the blood glucose meter when the blood glucose test strip is inserted into the blood glucose meter.

10. The blood glucose test strip method of claim 9, wherein the second conductive lead is electrically coupled to both the second pin and the fourth pin of the blood glucose meter when the blood glucose test strip is inserted into the blood glucose meter via a conductive bridge.

11. A blood glucose test strip for use in a six-pin blood glucose meter, comprising:
a substrate;
a first conductive lead disposed on a surface of the substrate;
a second conductive lead disposed on the surface of the substrate; and
a third conductive lead disposed on the surface of the substrate;
wherein a portion of each of the first conductive lead, the second conductive lead, and the third conductive lead resides within a blood sample chamber disposed on the surface of the substrate; and
wherein blood glucose testing is initiated by the blood glucose meter only when blood in the blood sample chamber electrically couples the first conductive lead and the third conductive lead.

12. The blood glucose test strip of claim 11, wherein the first conductive lead is electrically coupled to one or more of a fifth pin and a sixth pin of the blood glucose meter when the blood glucose test strip is inserted into the blood glucose meter.

13. The blood glucose test strip of claim 11, wherein the second conductive lead is electrically coupled to one or more of a second pin and a fourth pin of the blood glucose meter when the blood glucose test strip is inserted into the blood glucose meter.

14. The blood glucose test strip of claim 13, wherein the second conductive lead is electrically coupled to both the second pin and the fourth pin of the blood glucose meter when the blood glucose test strip is inserted into the blood glucose meter.

15. The blood glucose test strip of claim 14, wherein the second conductive lead is electrically coupled to both the second pin and the fourth pin of the blood glucose meter when the blood glucose test strip is inserted into the blood glucose meter via a conductive bridge.

16. The blood glucose test strip of claim 11, wherein the third conductive lead is electrically coupled to a third pin of the blood glucose meter when the blood glucose test strip is inserted into the blood glucose meter.
